(19) United States
(12) Patent Application Publication
(10) Pub. No.: US 2016/0318574 A1
(43) Pub. Date: Nov. 3, 2016

(54) MOVABLE END HEADS STRUCTURE FOR SYNCHRONOUS BRAKING

(71) Applicants: Chun-Rue Yang, (US); Chen-Chieh Liao, Taichung City (TW); Kuei-Ping Liao, Taichung City (TW)

(72) Inventors: Chun-Rue YANG, Taichung City (TW); Chen-Chieh LIAO, Taichung City (TW)

(21) Appl. No.: 14/699,606

(22) Filed: Apr. 29, 2015

(51) Int. Cl. B62L 3/08

(52) U.S. Cl. CPC B62L 3/08

(57) ABSTRACT

The present invention provides a movable end heads structure for synchronous braking, comprising an inner moving body, wherein top and bottom portions of the inner moving body are respectively provided with two active slots and two holes configured in an reverse staggered configuration. The holes and the active slots of the top portion enable brake cables and end heads thereof to be disposed therein. The holes and the active slots of the bottom portion enable control cables and end heads thereof to be disposed therein. The end heads of the brake cables move within the active slots of the top portion, and the end heads of the control cables move within the active slots of the bottom portion to pull any one of the control cables. When the two brake cables or both the two control cables are pulled simultaneously, the two brake cables are affected and pulled.

### BACKGROUND OF THE INVENTION

(a) Field of the Invention

The present invention relates to a movable end heads structure for synchronous braking, and more specifically to a movable end heads structure for synchronous braking that has particular application on bicycles and motorcycles, which uses end heads of two control cables of brake levers and end heads of two brake cables to actuate movement within active slots in an inner moving body. The non-fixed end heads are configured within the two sets of active slots in a reverse staggered configuration. Moreover, the end heads are not exposed outside the active slots when moving. When any one of the control cables is pulled, then the other control cable does not move, but the two brake cables are simultaneously affected and pulled, or pulling both the two control cables simultaneously affects pulling on the two brake cables, thus preventing the end heads from becoming jammed outside the active slots, and avoiding locking the braking system and disabling movement. During operation, the control cables and the brake cables do not curve, and are naturally subjected to the return force of the brake levers and the braking devices, whereby the control cables and the brake cables are returned to their original positions. In addition, there is no need to use any screw caps, screws or springs, thus avoiding conditions such as jamming and loosening from occurring.

(b) Description of the Prior Art

Accordingly to the prior art, a traditional synchronous braking structural device for bicycles is nothing more than one brake lever being used to brake one wheel, with the other brake lever being used for synchronous braking of the front and rear wheels; or one brake lever is used to brake the front and rear wheels, with the other brake lever also being used for synchronous braking of the front and rear wheels. Referring to FIG. 1, which shows a synchronous braking device 10, mainly comprising an outer cylinder 11, an inner cylinder 12, and a locking member 13. The inner cylinder 12 is disposed inside the outer cylinder 11, and the locking member 13 seals the outer cylinder 11 using a screwing method. The inner cylinder 12 is provided with a main slide groove 121 and an auxiliary slide groove 122. The main slide groove 121 enables displacement of a driving member 14 therein, and the auxiliary slide groove 122 enables displacement of a driven member 15 therein. The driving member 14 enables disposal of an end head 161 of a control cable 16 and an end head 181 of a brake cable 18 therein. The driven member 15 enables disposal of an end head 171 of a control cable 17 and an end head 191 of a brake cable 19 therein. The end head 161 of the control cable 16 and the end head 181 of the brake cable 18 inside the driving member 14 are of movable type. The end head 171 of the control cable 17 and the end head 191 of the brake cable 19 inside the driven member 15 are of fixed type. Displacement of the driving member 14 is able to drive and displace the driven member 15. The control cables 16 and 17 are connected to right and left brake levers respectively, and the brake cables 18 and 19 are connected to front and rear brake devices respectively.

When the control cable 16 within the driving member 14 is pulled, then the driving member 14 is pulled and displaced, thereby pulling the brake cable 18 within the driving member 14, at which time, the driving member 14 simultaneously displaces the driven member 15, thereby causing the brake cable 19 within the driven member 15 to be pulled and actuating synchronous braking. When only the control cable 17 within the driven member 15 is pulled, then the driven member 15 is pulled and displaced, thereby pulling the brake cable 19 within the driven member 15, at which time the driving member 14 is not displaced. Pulling of the brake cable 19 by the driven member 15 enables a braking action on one wheel, with no braking action being enabled on the other wheel.

The aforementioned invention of the prior art does not achieve synchronous braking by both the two brake levers. One brake lever only brakes one wheel, and the other brake lever enables braking on the front and rear wheels. When the end head 171 of the control cable 17 is displaced, then the end head 161 of the other control cable 16 does not move. When the end head 191 of the brake cable 19 is displaced, then the end head 181 of the other brake cable 18 does not move. Such a braking device is of a traditional synchronous braking type, and a rider is often unable to determine which brake lever to squeeze in an emergency. Moreover, because the locking member 13 seals the outer cylinder 11 using a screwing method, and further enables the two brake cables 18, 19 to pass back and forth therethrough, thus, such a braking system easily results in the locking member 13 coming loose.

Referring to FIG. 2, which shows a second type of a traditional synchronous braking device 20, mainly comprising an outer cylinder 21 and an inner cylinder 22. The inner cylinder 22 is disposed inside the outer cylinder 21. The front and rear of the outer peripheries of the inner cylinder 22 are provided with locating slots 223, 224 and 221, 222 respectively. The two front locating slots 223, 224 enable end heads 251, 261 of two brake cables 25, 26 to be respectively disposed therein, and the two rear locating slots 221, 222 enable end heads 231, 241 of two control cables 23, 24 to be respectively disposed therein. The end heads 231, 241 of the two control cables 23, 24 and the end heads 251, 261 of the two brake cables 25, 26 are of fixed type. The control cables 23 and 24 are respectively connected to brake levers, and the brake cables 25 and 26 are respectively connected to front and rear braking devices. Pulling any one of the end heads 231, 241 of the control cables 23, 24 connectively drives the inner cylinder 22, and the inner cylinder 22 then connectively drives the two brake cables 25, 26.

In the second type of traditional synchronous braking device 20, one brake lever enables braking of the front and rear wheels, and the other brake lever also enables braking of the front and rear wheels. Although the braking device 20 provides synchronous braking of the front and rear wheels, however, when squeezing a single brake lever, then the control cable 23 of the brake lever connectively moves, while the control cable 24 of the other brake lever does not move. Consequently, the control cable 24 is squeezed by the inner cylinder 22 and is easily compressed and deformed within the outer cylinder 21. Hence, because the inner cylinder 22 compresses and deforms the control cable 24, thus, the control cable 24 can no longer be displaced, or is jammed and unable to easily move. Accordingly, squeezing a single brake lever is unable to complete braking to the fullest extent. Thus, there are misgivings on safety, and is the first major shortcoming of such a synchronous braking device. Or, brute force could be used to squeeze the brake lever and force pulling of the control cable 24, at which time, the fingers would need to absorb such a large squeezing force, thereby requiring even greater effort to affect complete braking compared to other structural types of synchronous braking devices, and is the second major shortcoming of such a synchronous braking device.

Or in the aforementioned invention, screw caps are respectively disposed on the end heads 231, 241 of the two control cables 23, 24 and the end heads 251, 261 of the two brake cables 25, 26, and screw caps are respectively screwed onto screw threads of the inner cylinder 22 to enable adjusting the brake clamping distance. However, the screw caps will come loose or fall off after a period of use, resulting in even greater risk to safety, and is the main shortcoming of the synchronous braking device 20.

Referring to FIG. 3, which shows a third type of a traditional synchronous braking device 30, which comprises a housing 31, and a synchronizing member 32 installed inside the housing 31. The synchronizing member 32 is able to slide back and forth within the housing 31. The left side of the center of the synchronizing member 32 is connected to one end of a control cable 33 of a left brake lever passing through the housing 31, and the right side of the center of the synchronizing member 32 is connected to one end of a control cable 34 of a right brake lever passing through the housing 31. One side end edge of the aforementioned synchronizing member 32 is connected to one end of a brake cable 35, which passes through the housing 31, of a front wheel of a two-wheeled vehicle, and another side end edge of the synchronizing member 32 is connected to one end of a brake cable 36, which passes through the housing 31, of a rear wheel of a two-wheeled vehicle. Actuating the control cable 33 of the left brake lever and/or the control cable 34 of the right brake lever simultaneously drive(s) the front wheel brake cable 35 and the rear wheel brake cable 36 through use of the synchronizing member 32.

The front wheel brake cable 35 and the rear wheel brake cable 36 are fixedly locked to the synchronizing member 32 within the housing 31 using screw caps 37 and screw stems 38, thus, the screw caps 37 and screw stems 38 are used to serve as locating parts for all the components within the synchronous braking device 30. However, the screw caps 37 easily come loose from the screw stems 38, causing unreliable braking, or the screw caps 37 come off the screw stems 38, which disables braking and thus endangers the safety and life of the rider.

### SUMMARY OF THE INVENTION

Traditional synchronous braking devices for bicycles include bicycles having one brake lever that is only able to effect braking of one wheel, while the other brake lever enables braking on the front and rear wheels, and also include bicycles having two brake levers that are able to effect synchronous braking, with end heads of control cables and brake cables each being of fixed type or movable type. With such a variety of different structures, some require great effort to be applied on the brake levers; some cannot effect braking to the fullest extent; and the components of some easily come loose or the components become jammed, causing unreliable braking. All of the aforementioned are common defects of synchronous braking devices of the prior art.

Accordingly, the present invention relates to a movable end heads structure for synchronous braking, comprising:

An outer cylinder, within which is provided with a space. The top and bottom of the outer cylinder are provided with a top cover and a bottom cover respectively, and the top cover and the bottom cover are each provided with a plurality of through holes. The periphery of each of the through holes of the top cover and the bottom cover is provided with a locating groove. The through holes enable brake cables of a bicycle or a motorcycle or control cables of a bicycle or a motorcycle to pass therethrough. The brake cables and the control cables are each provided with a covering cable, the end portions of which respectively butt against the insides of the locating grooves, thereby enabling the top cover and the bottom cover to be located on an outer cylinder without coming loose.

An inner moving body, which is disposed and slides within the space of the outer cylinder. The top portion of the outer cylinder, from the top portion downwards, is provided with two active slots and two holes, and the bottom portion of the outer cylinder, from the bottom portion upwards, is similarly provided with two active slots and two holes. The internal diameter of the active slots is greater than that of the holes. Moreover, the active slots and the holes of the top portion and the active slots and the holes of the bottom portion are disposed in an reverse staggered configuration. The holes and the active slots of the top portion enable brake cables and end heads thereof to be disposed therein. The holes and the active slots of the bottom portion enable control cables and end heads thereof to be disposed therein.

Accordingly, the inner moving body is displaced relative to the outer cylinder, and the end heads of the brake cables move within the active slots relative to the top portion of the inner moving body without being exposed outside the active slots. Moreover, the end heads of the control cables move within the active slots relative to the bottom portion of the inner moving body without being exposed outside the active slots. When any one of the control cables is pulled, then the other control cable does not move, but simultaneously pulls the two brake cables, or when both the two control cables are pulled, then the two brake cables are simultaneously pulled without the end heads becoming jammed outside the active slots, thereby preventing locking the braking system and disabling movement. When operating, the control cables and the brake cables do not curve, and are naturally subjected to the return force of the brake levers and the braking devices, which enables the control cables and the brake cables to be pulled back without the need to use any screw caps, thus avoiding conditions such as jamming and loosening from occurring.

The primary objective of the movable end heads structure for synchronous braking of the present invention is to enable the end heads of the two control cables and the end heads of the two brake cables to move in the different directional active slots, and not be fixed within the structure. Moreover, the end heads are not exposed outside the active slots when moving. When any one of the control cables is pulled, then the other control cable does not move, but simultaneously pulls the two brake cables, or when both the two control cables are pulled, then the two brake cables are simultaneously pulled, thus preventing the end heads from becoming jammed outside the active slots. and avoiding locking the braking system and disabling movement. In addition, the control cables and the brake cables are naturally subjected to the return force of the brake levers and the braking devices, which enables the control cables and the brake cables to be pulled back without the need to use any screw caps, screws, or springs, thus avoiding conditions such as jamming and loosening from occurring.

Another objective of the movable end heads structure for synchronous braking of the present invention is to provide smooth displacement of the inner moving body within the outer cylinder without the need to increase squeezing force on the brake lever.

Yet another objective of the movable end heads structure for synchronous braking of the present invention is to provide the function whereby when squeezing a single brake lever, then the control cable of the other brake lever does not deform, and is not subjected to pressing from the inner moving body, while enabling complete braking to the fullest extent, with no misgivings on safety.

And yet another objective of the movable end heads structure for synchronous braking of the present invention is to provide a covering cable for each of the brake cables and the control cables of the top cover and the bottom cover, and the covering cables are fixed-length restraints, which enable the top cover and the bottom cover to be fixedly positioned in the outer cylinder without disengaging and coming loose.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic cross-sectional view of one type of synchronous braking device of the prior art.

FIG. 2 is a schematic cross-sectional view of a second type of synchronous braking device of the prior art.

FIG. 3 is a planar schematic view of a third type of synchronous braking device of the prior art.

FIG. 4 is an exploded elevational schematic view of a main directional shaft portion of the present invention.

FIG. 5 is an assembled elevational schematic view of the main directional shaft of the present invention.

FIG. 6 is an exploded elevational schematic view of the present invention.

FIG. 7 is an assembled elevational schematic view of the present invention.

FIG. 8 is a schematic cross-sectional view of an outer cylinder and an inner moving body of the present invention not yet assembled with control cables and brake cables.

FIG. 9 is a longitudinal schematic cross-sectional view of the present invention (the cross-section is along the direction of the control cable).

FIG. 10 is a transverse schematic cross-sectional view of the present invention (the cross-section is along the direction of the brake cable).

FIG. 11 is a schematic cross-sectional view depicting pulling one of the control cables according to the present invention.

FIG. 12 is a schematic cross-sectional view depicting pulling the other control cable according to the present invention.

FIG. 13 is a schematic cross-sectional view of synchronous action of the brake cables according to the present invention.

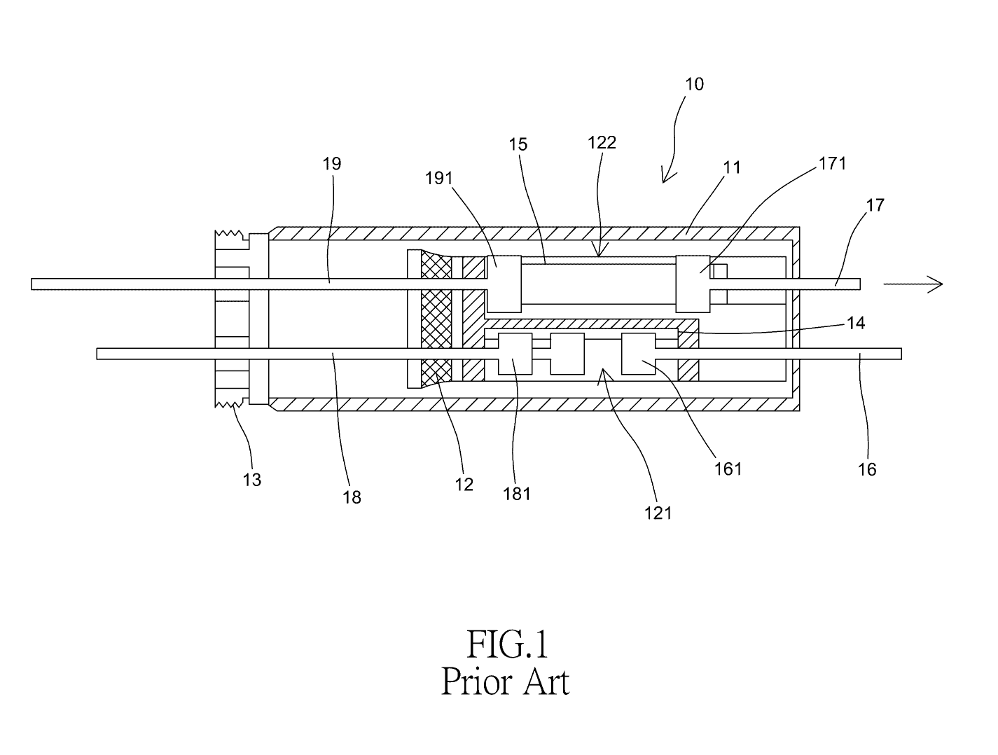

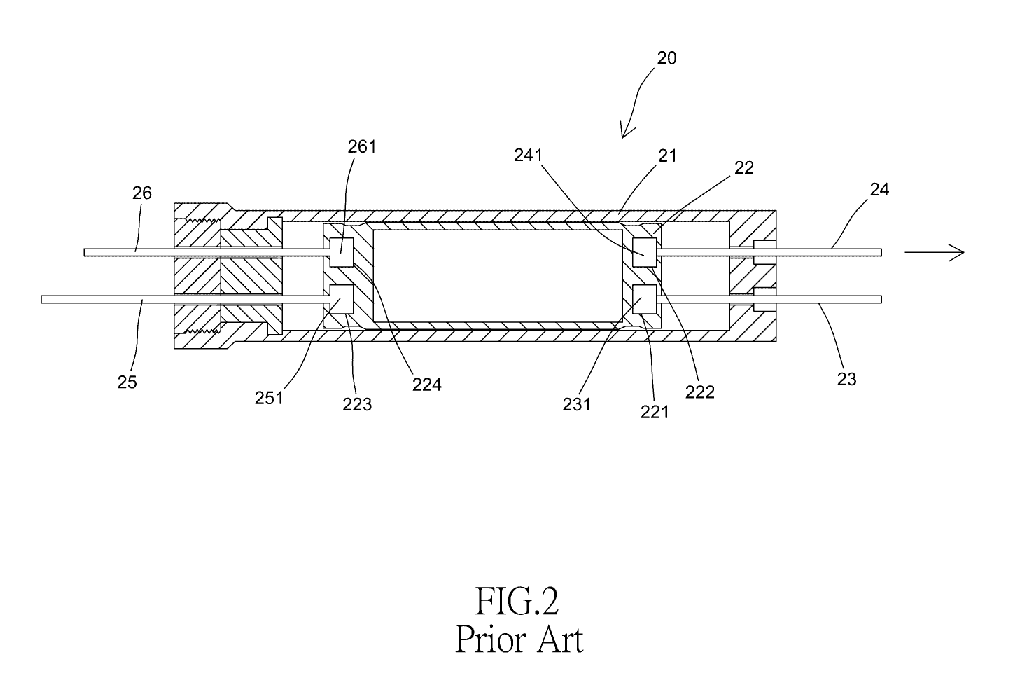

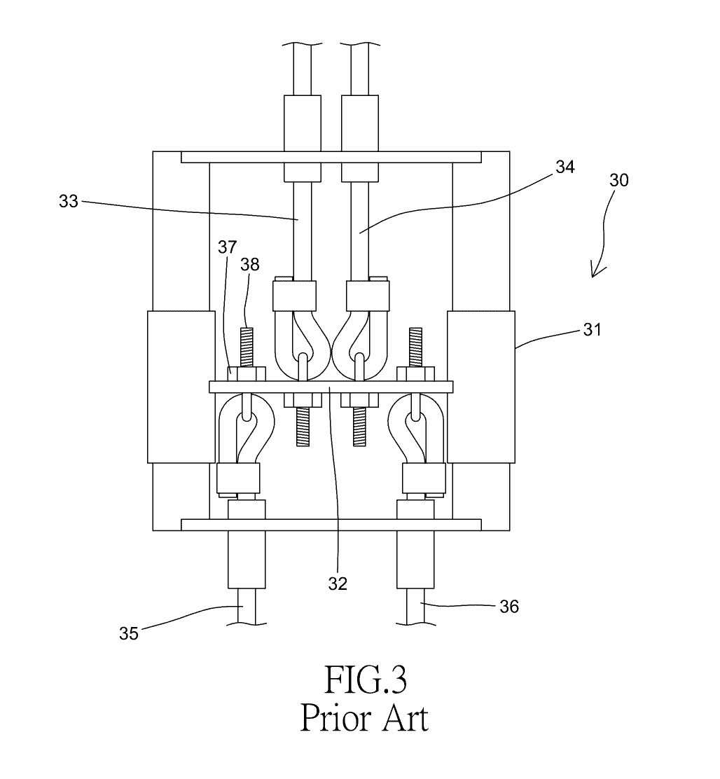

### DETAILED DESCRIPTION OF THE PREFERRED EMBODIMENTS

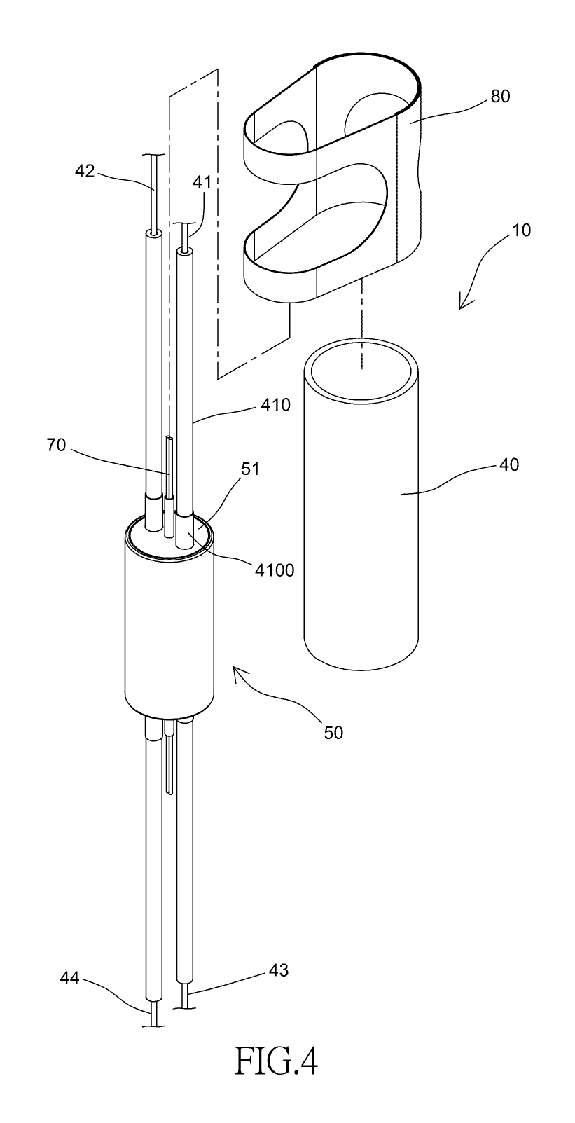

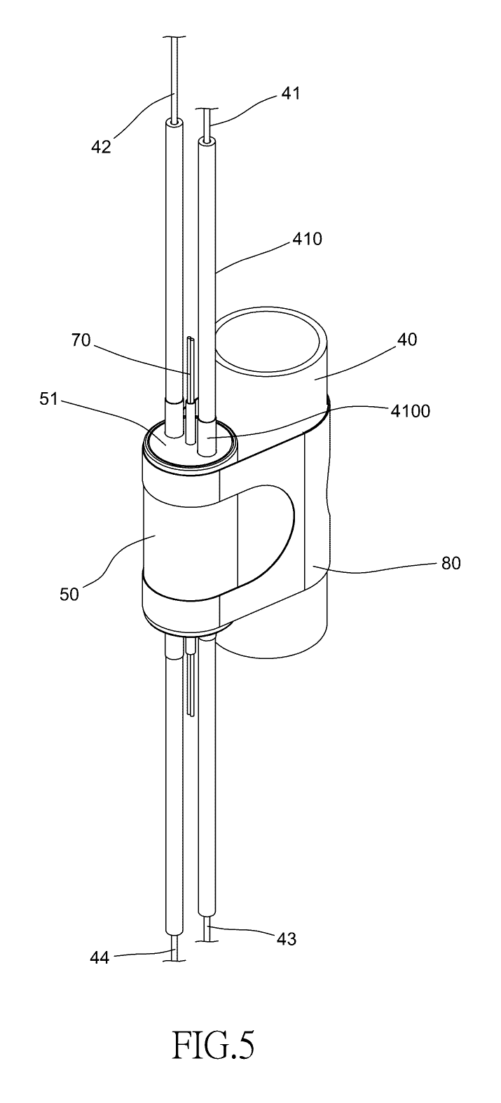

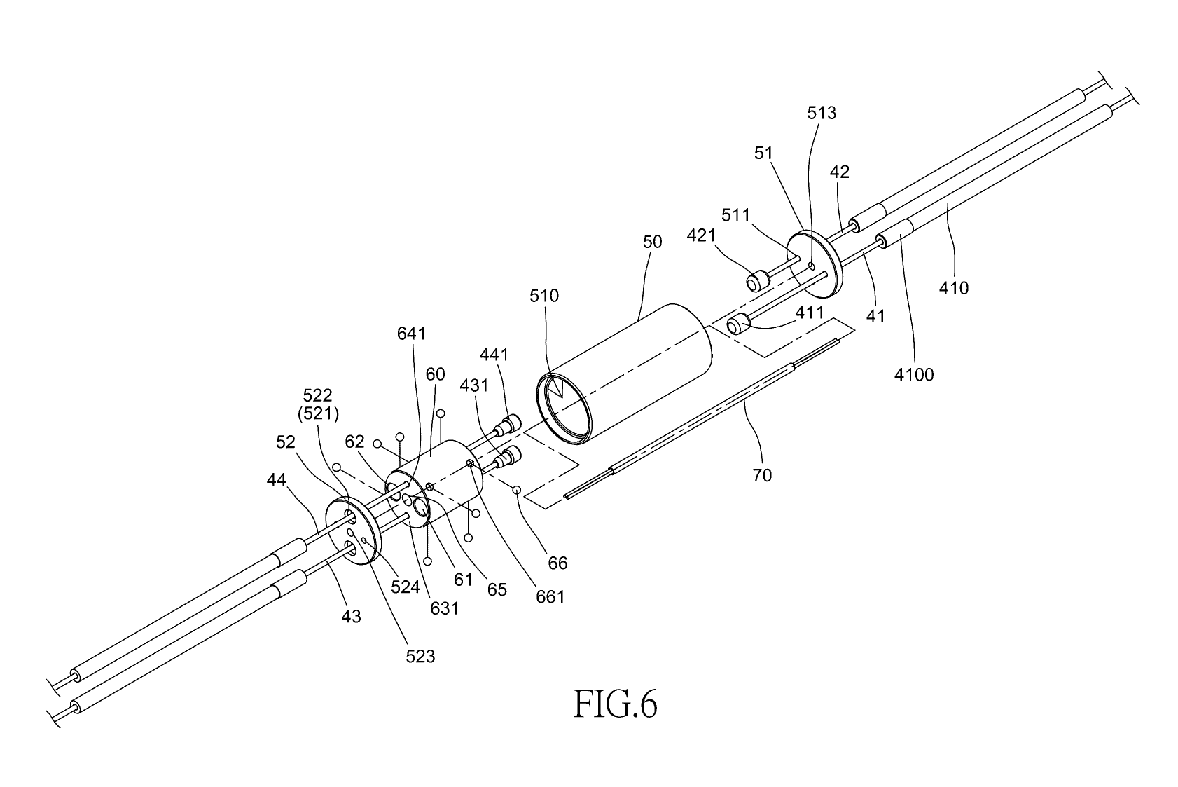

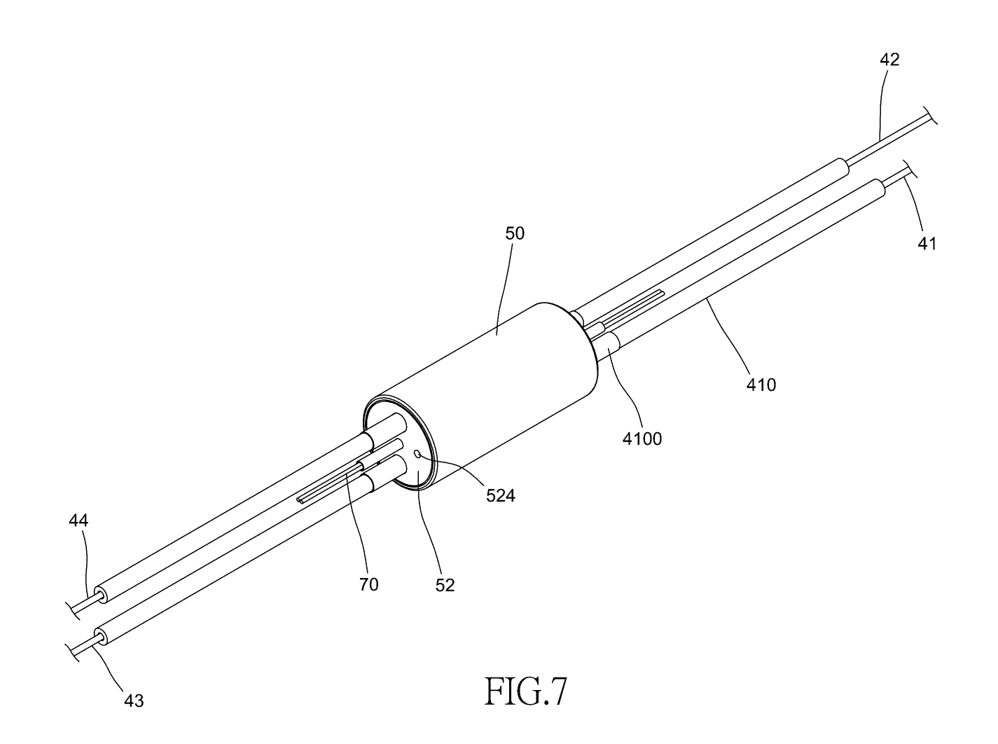

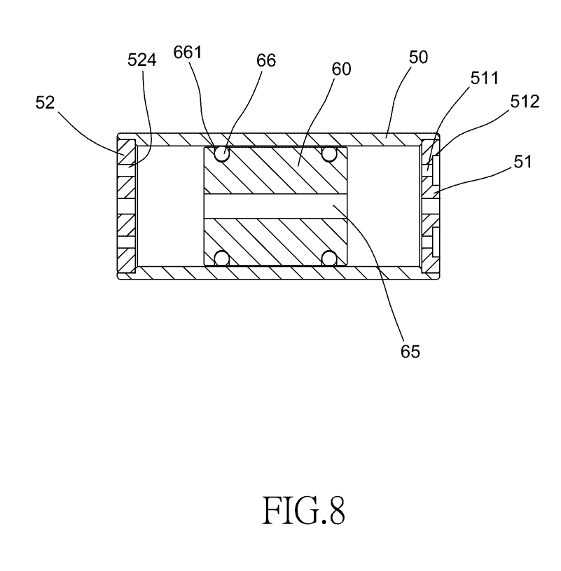

Referring to FIGS. 4 to 10, which show a movable end heads structure for synchronous braking of the present invention, wherein the movable end heads structure for synchronous braking is mounted on a directional main shaft 40 of a bicycle or a motorcycle, and is located between control cables 41, 42 and brake cables 43, 44 of brake levers. The present invention comprises an outer cylinder 50, an inner moving body 60, the two brake cables 43, 44 of a bicycle or a motorcycle, the two control cables 41, 42 of two brake levers of a bicycle or a motorcycle, a top cover 51, and a bottom cover 52. A covering piece 80 is used to coaxially join and fixedly position the outer cylinder 50 to the directional main shaft 40. The covering piece 80 can use a screw method to fixedly position the outer cylinder 50. A space 510 is provided within the outer cylinder 50 (as depicted in FIGS. 6, 8, 9, 10), which enables the inner moving body 60 to be disposed therein. The top and bottom of the outer cylinder 50 are provided with the top cover 51 and the bottom cover 52 respectively. The top cover 51 is provided with a plurality of through holes 511, and the bottom cover 52 is also provided with a plurality of through holes 521. The outer peripheries of the through holes 511 of the top cover 51 and the through holes 521 of the bottom cover 52 are provided with locating grooves 512, 522 respectively (as depicted in FIGS. 8, 9, 10). The through holes 521 enable the brake cables 43 (44) of a bicycle or a motorcycle to pass therethrough, and the through holes 511 enable the control cables 41 (42) of the brake levers of a bicycle or a motorcycle to pass therethrough. The bottom cover 52 is provided with water leakage holes 524, which function to remove rain water and expel air (the leakage holes 524 are used to expel air pressure produced when the inner moving body 60 is moving). The brake cables 43 (44) and the control cables 41 (42) are all provided with covering cables 410, and the end portions of the covering cables 410 are respectively sleeved with a metal sleeve 4100 to butt within the locating grooves 512 of the top cover 51 and the locating grooves 522 of the bottom cover 52. Because the covering cables 410 are located between the brake levers and the top cover 51, thus, the length thereof is fixed, and the top cover 51 located on the outer cylinder 50 will not disengage and come loose. Similarly, because the covering cables 410 are located between the bottom cover 52 and the braking devices, thus, the length thereof is fixed, and the bottom cover 52 located on the outer cylinder 50 will not disengage and come loose. The centers of the top cover 51 and the bottom cover 52 are provided with outer center holes 513, 523 respectively. The control cables 41 and 42 are subjected to the pulling force of the brake levers, and the brake cables 43, 44 are subjected to the pulling force of the braking devices. The covering cables 410 are not subjected to any pulling force, and only have a covering function.

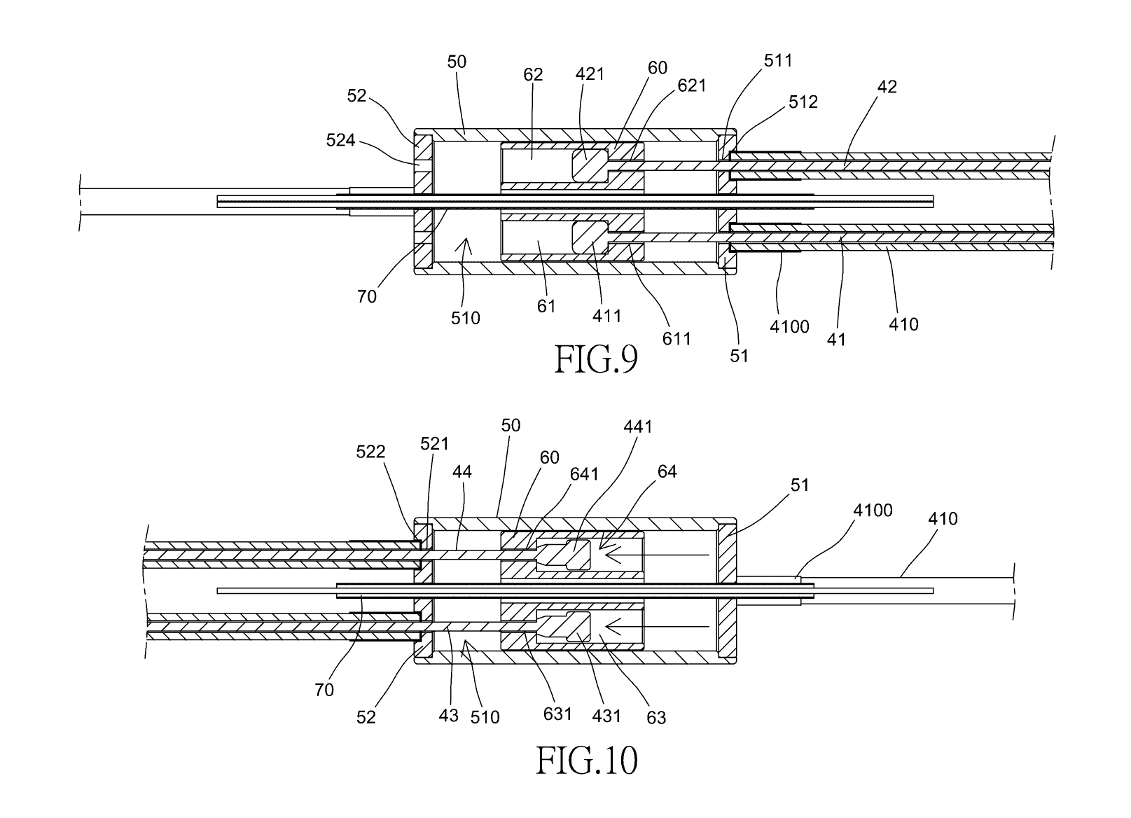

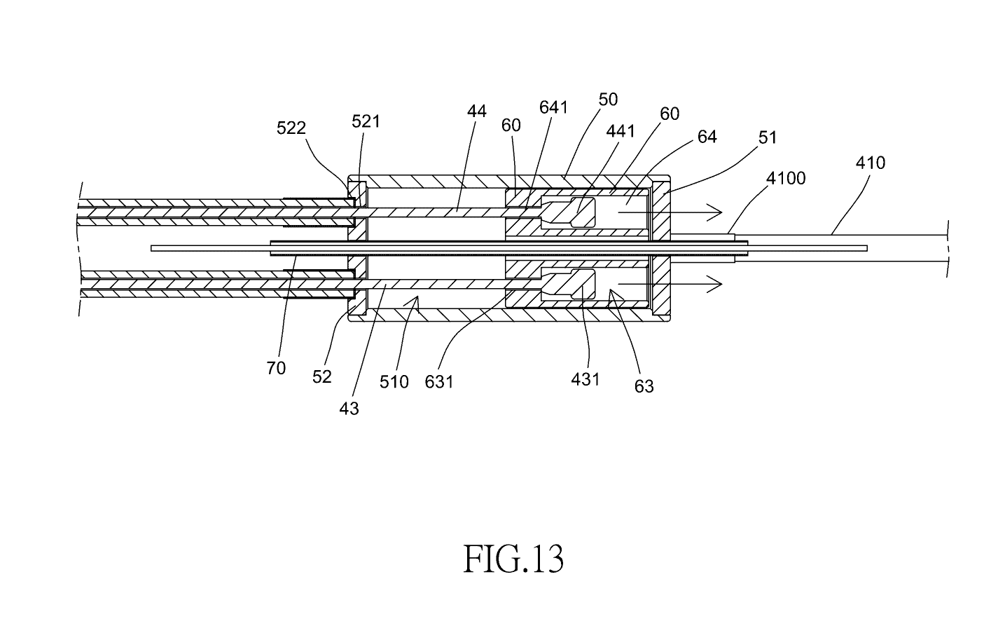

Referring to FIGS. 10 and 13, the inner moving body 60 is able to slide within the space 510 of the outer cylinder 50, and the inner moving body 60, from the top portion downwards, is respectively provided with two active slots 63, 64 and two holes 631, 641. The internal diameter of the active slots 63, 64 is greater than that of the holes 631, 641. The brake cables 43, 44 and end heads 431, 441 thereof are disposed within the two active slots 63, 64 and the two holes 631, 641, respectively, with the brake cables 43, 44 penetrating the two holes 631, 641. The end heads 431, 441 are able to move and displace within the active slots 63, 64. However, the end heads 431, 441 do not become exposed outside the active slots 63, 64 when moved and displaced, thus preventing the end heads 431, 441 from becoming jammed on the outer edges of the active slots 63, 64, and avoiding locking the braking device. Referring to FIGS. 8, 9, 10, 11, 12, The inner moving body 60, from the bottom portion upwards, is respectively provided with two active slots 61, 62 and two holes 611, 621. The internal diameter of the active slots 61, 62 is greater than that of the holes 611, 621. The control cables 41, 42 and end heads 411, 421 thereof are disposed within the two active slots 61, 62 and the two holes 611, 621, respectively, with the control cables 41 and 42 penetrating the two holes 611, 621. The end heads 411, 421 are able to move and displace within the active slots 61, 62. However, the end heads 411, 421 do not become exposed outside the active slots 61, 62 when moved and displaced, thus preventing the end heads 411, 421 from becoming jammed on the outer edges of the active slots 61, 62, and avoiding locking the braking device. Moreover, the two active slots 63, 64 and the two holes 631, 641 at the top portion, and the active slots 61, 62 and the two holes 611, 621 at the bottom portion are disposed in a reverse staggered configuration (distribution forms a longitudinal, transverse crisscross configuration). The control cables 41, 42 respectively disposed within the active slots 61, 62 at the bottom portion and the end heads 411, 421 thereof are of movable type (the end heads 411, 421 can displace within the active slots 61, 62). The brake cables 43, 44 respectively disposed within the active slots 63, 64 at the top portion and the end heads 431, 441 thereof are also of movable type (the end heads 431, 441 can displace within the active slots 63, 64). The center of the internal moving body 60 is provided with an inner center hole 65. The inner center hole 65 and the outer center holes 513, 523 of the outer cylinder 50 are configured on the same center line (as depicted in FIG. 6). The outer center holes 513, 523 and the inner center hole 65 enable an electric cable 70 (an enamel-covered cable, within which has a plurality of electric wires) to enter therein to serve as a power supply cable for brake lights or turn signals. The surface of the inner moving body 60 is provided with a plurality of semicircular recesses 661, and a ball 66 is inserted in each of the semicircular recesses 661, thereby causing the balls 66 to be disposed between the outer cylinder 50 and the inner moving body 60, thus enabling unhindered internal displacement of the inner moving body 60 within the outer cylinder 50.

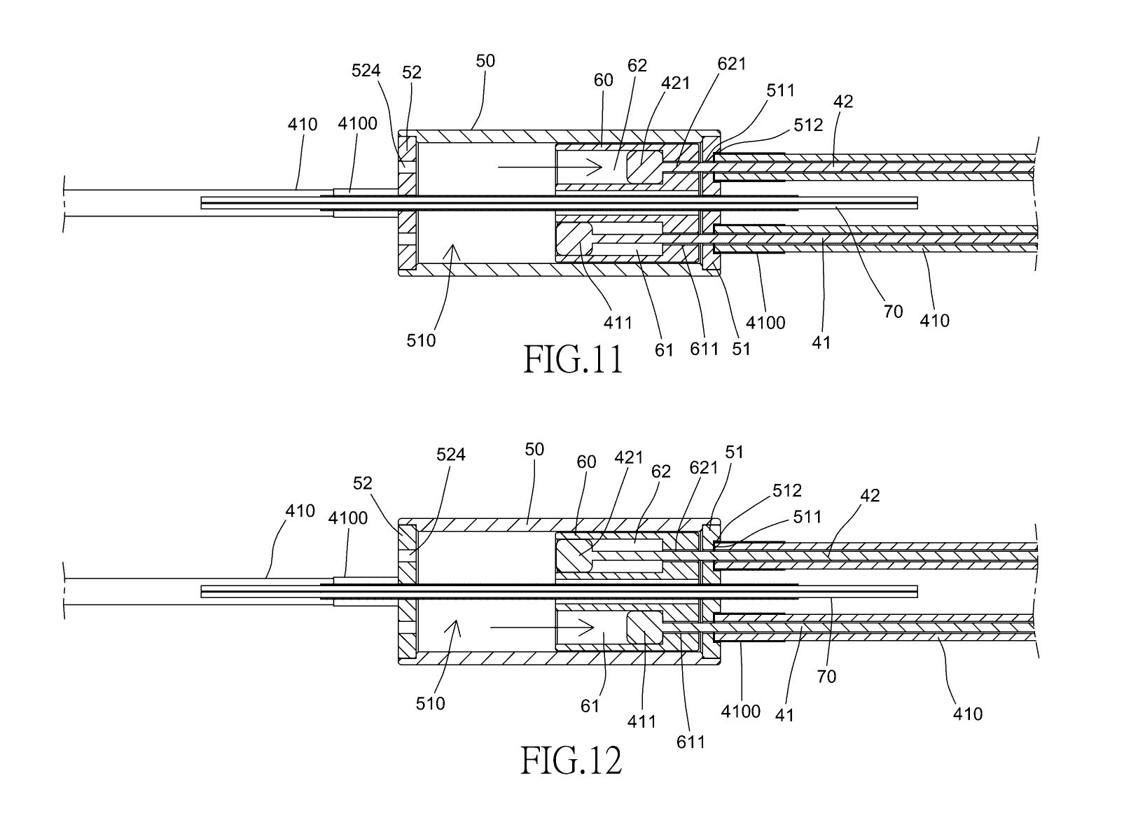

According to the improvements in the aforementioned structure of the present invention as disclosed above, when operating the movable end heads structure for synchronous braking, one brake lever (left side) of a bicycle or a motorcycle pulls the control cable 41 and the end head 411 thereof (as depicted in FIGS. 9, 12), which pulls the end head 411 and displaces the inner moving body 60 (displacing the inner moving body 60 upwards), at which time, the control cable 42 of the other brake lever (right side) and the end head 421 thereof do not move. The end head 421 seemingly moves back relative to the position of the inner moving body 60 and comes close to the outer edge of the active slot 62 (in fact, the control cable 42 of the other brake lever and the end head 421 thereof do not move). Moreover, displacement of the inner moving body 60 is used to synchronously pull the two end heads 431, 441 and the brake cables 43, 44 thereof (as depicted in FIG. 13). The two brake cables 43 and 44 transmit the pulling force to the braking devices, thereby performing synchronous braking of the front and rear wheels of a bicycle or a motorcycle. Similarly, if one brake lever of a bicycle or a motorcycle (right side) pulls the control cable 42 and the end head 421 thereof (as depicted in FIGS. 9, 11), then pulling and displacement of the inner moving body 60 is actuated (displacing the inner moving body 60 upwards), at which time, the control cable 41 of the other brake lever (left side) and the end head 411 thereof do not move, while displacement of the inner moving body 60 synchronously pulls the two end heads 431, 441 and the brake cables 43, 44 thereof, then the two brake cables 43 and 44 transmit the pulling force to the braking devices, thereby performing synchronous braking of the front and rear wheels of a bicycle or a motorcycle. If the two control cables 41, 42 are pulled at the same time, it is clear that the inner moving body 60 will be displaced, and the two brake cables 43, 44 will perform synchronous braking of the front and rear wheels of a bicycle or a motorcycle. Accordingly, it does not matter which brake lever is first actuated. Assembly of the present invention on a bicycle or motorcycle provides a smaller clamping distance for the rear wheel braking device than the clamping distance for the front wheel braking device. Hence, although the inner moving body 60 causes a synchronous action of both the front and rear braking devices, however, braking is effected on the rear wheel before the front wheel to prevent overturning the bicycle or motorcycle.

In the present invention, the inner moving body 60 is able to displace relative to the outer cylinder 50, and the end heads 431, 441 of the brake cables 43, 44, move within the active slots 63, 64 at the top portion relative to the inner moving body 60 without the end heads 431, 441 becoming exposed outside the active slots 63, 64. In addition, the end heads 411, 421 of the brake cables 41, 42, move within the active slots 61, 62 at the bottom portion relative to the inner moving body 60 without the end heads 411, 421 becoming exposed outside the active slots 61, 62. Pulling any one of the control cables 41 (42) does not cause the other control cable 42 (41) to move, but simultaneously affects pulling of the two brake cables 43, 44; or pulling both the two control cables 41, 42 simultaneously affects pulling of the two brake cables 43, 44, thus, each of the end heads 411, 421, 431, 441 do not become jammed outside the active slots 61, 62, 63, 64, and locking of the braking system and disabling the bicycle or motorcycle from moving is prevented. When operating the present invention, the control cables 41 and 42 and the brake cables 43, 44 do not curve, and are naturally subjected to the return force of the brake levers and the braking devices, which enables the control cables 41, 42 and the brake cables 43, 44 to be pulled back without the need to use any screw caps, screws or springs, thus avoiding conditions such as jamming and loosening from occurring.

When force is applied to one brake lever, because the control cable 41 (42) of the other brake lever does not deform or move, thus, there are no obstructions hindering application of the force, and the inner moving body 60 can be completely displaced. The control cable 41 (42) is also not deformed or compressed, thus avoiding conditions such as jamming and hindered movement from occurring. Accordingly, when squeezing a single brake lever, the rider is able to complete braking to the fullest extent without conditions such as jamming, which would disable the system from returning to its original state, from occurring. Hence, there are no misgivings regarding safety when using the present invention. The balls 66 are further provided between the innerI moving body 60 and the outer cylinder 50, thereby enabling smooth displacement of the inner moving body 60 within the outer cylinder 50 without the need to increase force when squeezing the brake levers, which saves on effort required compared to general synchronous braking devices.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A movable end heads structure for synchronous braking, comprising:
an outer cylinder, a space is provided within the outer cylinder, top and bottom of the outer cylinder are provided with a top cover and a bottom cover respectively, the top cover and the bottom cover are each provided with a plurality of through holes, and the periphery of each of the through holes of the top cover and the bottom cover is provided with a locating groove; the through holes enable brake cables or control cables of handles of a bicycle or a motorcycle to pass therethrough, the brake cables and the control cables are respectively provided with a covering cable, an end portions of the covering cables are respectively sleeved with a metal sleeve to butt within the respective locating grooves of the top cover and the bottom cover, thereby enabling the top cover and the bottom cover to be fixedly positioned in the outer cylinder without coming loose; the bottom cover is further provided with water leakage holes;
an inner moving body, the inner moving body is disposed and slides within the space of the outer cylinder, top portion of the outer cylinder, from the top portion downwards, is provided with two active slots and two holes, and bottom portion of the outer cylinder, from the bottom portion upwards, is provided with two active slots and two holes, internal diameter of the active slots is greater than that of the holes, moreover, the active slots and the holes of the top portion and the active slots and the holes of the bottom portion are disposed in a reverse staggered configuration; the holes and the active slots of the top portion enable the brake cables and end heads thereof to be disposed therein, and the holes and the active slots of the bottom portion enable the control cables and end heads thereof to be disposed therein;
whereby the inner moving body is able to be displaced relative to the outer cylinder, the end heads of the brake cables move within the active slots relative to the top portion of the inner moving body, and are not exposed outside the active slots; the end heads of the control cables move within the active slots relative to the bottom portion of the inner moving body, and are not exposed outside the active slots; when any one of the control cables is pulled, the other control cable does not move, while simultaneously pulling the two brake cables, or when both the two control cables are pulled, then the two brake cables are simultaneously affected and pulled, and the end heads do not become jammed outside the active slots, thereby preventing locking a braking system and disabling movement; when operating, the control cables and the brake cables do not curve, and are naturally subjected to the pulling force of the brake levers and the braking devices and return to original position, without the need to use any screw caps, thus avoiding conditions such as jamming and loosening from occurring.

2. The movable end heads structure for synchronous braking according to claim 1, wherein centers of the top cover and the bottom cover of the outer cylinder are each provided with an outer center hole, and the center of the inner moving body is provided with an inner center hole; the outer center hole and the inner center hole enable an electric cable to respectively pass therethrough and serve as a power supply cable for brake lights or turn signals.

3. The movable end heads structure for synchronous braking according to claim 1, wherein surface of the inner moving body is provided with a plurality of semicircular recesses, and a ball is inserted in each of the semicircular recesses causing the balls to be disposed between the outer cylinder and the inner moving body.

4. The movable end heads structure for synchronous braking according to claim 1, wherein the outer cylinder is coaxially joined and fixedly positioned to a preset position of a bicycle or a motorcycle using a covering piece.
